(19) United States
(12) Patent Application Publication
(10) Pub. No.: US 2011/0217048 A1
(43) Pub. Date: Sep. 8, 2011

(54) Delayed interferometer and optical receiver

(75) Inventors: Takashi Shimizu, Kawasaki (JP); Takashi Yamane, Kawasaki (JP)

(73) Assignee: Fujitsu Optical Components Limited, Kawasaki (JP)

(21) Appl. No.: 12/929,784

(22) Filed: Feb. 15, 2011

(30) Foreign Application Priority Data
Mar. 8, 2010 (JP) 2010-050944

(51) Int. Cl. H04B 10/06; G02F 2/00

(52) U.S. Cl. 398/202; 359/325

(57) ABSTRACT

A delayed interferometer includes a branching unit that branches an optical signal into a first optical signal and a second optical signal; a guiding unit that guides the first optical signal in a first optical path to delay the first optical signal when a polarization direction of the first optical signal is the first direction, and guides the first optical signal in a second optical path when the polarization direction of the first optical signal is the second direction perpendicular to the first direction; a demodulating unit that causes the first optical signal guided in the first optical path or the second optical path and the second optical signal branched by the branching unit to interfere with each other, thereby demodulating the optical signal; and a polarization direction adjusting unit to adjust the polarization direction of the first optical signal in the first direction or the second direction.

### CROSS-REFERENCE TO RELATED APPLICATION

This application is based upon and claims the benefit of priority of the prior Japanese Patent Application No. 2010-050944, filed on Mar. 8, 2010, the entire contents of which are incorporated herein by reference.

### FIELD

The embodiments discussed herein are directed to a delayed interferometer and an optical receiver.

### BACKGROUND

In recent years, a phase modulation (DPSK: Differential Phase-Shift Keying) system is paid attention as a modulation system for realizing a high-speed and large-capacity optical transmission system. The phase modulation system uses a phase difference of lights to modulate an optical signal. Typically, the optical transmission system employs a delayed interferometer for demodulating an optical signal modulated by the phase modulation system (which will be called “modulated signal” hereinafter). The delayed interferometer causes an input modulated signal and an optical signal which is obtained by delaying the modulated signal by one bit to interfere with each other, thereby to demodulate the modulated signal.

In the optical transmission system, an external device such as interleaver may be additionally arranged on a transmission path upstream of the delayed interferometer. When the external device is additionally arranged on the transmission path upstream of the delayed interferometer, an optical signal-to-noise ratio (OSNR) may deteriorate. In recent years, there is known that it is effective that the amount of delay for delaying the modulated signal is changed from one bit to less than one bit in the delayed interferometer in order to restrict the deterioration in OSNR.

There is known, as the technique for changing the amount of delay of an optical signal, a technique in which a movable mirror is arranged on an optical path for delaying a modulated signal by one bit and the movable mirror is mechanically moved to reduce a length of the optical path, thereby changing the amount of delay from one bit to less than one bit.

Patent Document 1: Japanese Laid-open Patent Publication No. 2007-306371

However, in the conventional technique in which an optical component such as movable mirror is mechanically moved to reduce a length of an optical path, there is a problem that a movement accuracy of the optical component is low and thus the amount of delay is difficult to accurately change.

### SUMMARY

According to an aspect of an embodiment of the invention, a delayed interferometer includes a branching unit that branches an optical signal modulated by a phase modulation system into a first optical signal and a second optical signal; a guiding unit that acquires the first optical signal branched by the branching unit, guides the first optical signal in a first optical path to delay the first optical signal by one bit when a polarization direction of the acquired first optical signal is the first direction, and guides the first optical signal in a second optical path having an optical distance shorter than that of the first optical path when the polarization direction of the first optical signal is the second direction perpendicular to the first direction; a demodulating unit that causes the first optical signal guided in the first optical path or the second optical path by the guiding unit and the second optical signal branched by the branching unit to interfere with each other, thereby demodulating the optical signal; and a polarization direction adjusting unit that judges a code error rate of the optical signal demodulated by the demodulating unit to adjust the polarization direction of the first optical signal acquired by the guiding unit in the first direction or the second direction.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram illustrating a structure of a delayed interferometer according to a first embodiment;

FIG. 2 is a diagram illustrating a structure of an optical receiver including a delayed interferometer according to a second embodiment;

FIG. 3 is a diagram illustrating a structure of the delayed interferometer according to the second embodiment;

FIG. 4 is a flowchart illustrating a processing procedure by the delayed interferometer according to the second embodiment;

FIG. 5 is a diagram illustrating a structure of a delayed interferometer according to a third embodiment;

FIG. 6 is a flowchart illustrating a processing procedure by the delayed interferometer according to the third embodiment;

FIG. 7 is a diagram illustrating a structure of a delayed interferometer according to a fourth embodiment; and

FIG. 8 is a flowchart illustrating a processing procedure by the delayed interferometer according to the fourth embodiment.

### DESCRIPTION OF EMBODIMENTS

Preferred embodiments of the present invention will be explained with reference to accompanying drawings. The following embodiments do not intend to limit the delayed interferometer and the optical receiver disclosed in the present application.

### [a] First Embodiment

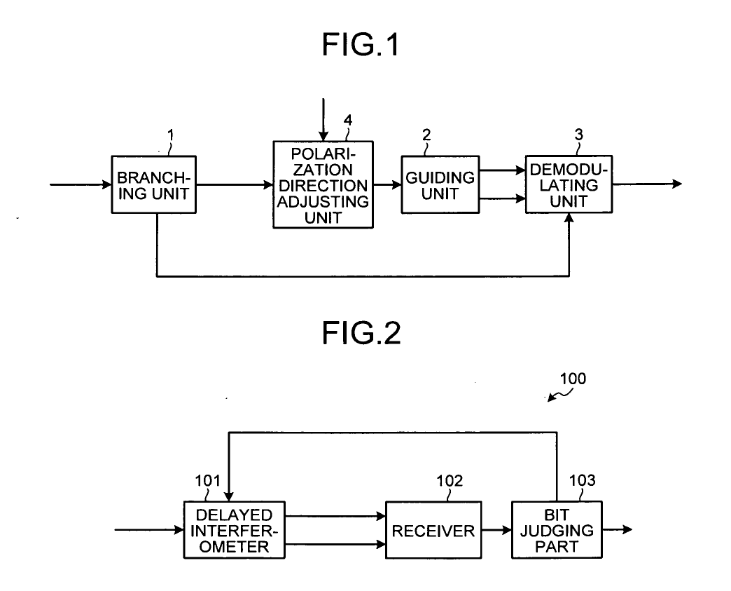

A structure of a delayed interferometer according to a first embodiment will be described first. FIG. 1 is a diagram illustrating a structure of the delayed interferometer according to the first embodiment. As illustrated, the delayed interferometer according to the first embodiment includes a branching unit 1, a guiding unit 2, a demodulating unit 3, and a polarization direction adjusting unit 4. The branching unit 1 branches a modulated signal which is an optical signal modulated by a phase modulation system into a first optical signal and a second optical signal.

The guiding unit 2 acquires the first optical signal branched by the branching unit, and when the polarization direction of the obtained first optical signal is a first direction, guides the first optical signal in a first optical path for delaying the first optical signal by one bit. When the polarization direction of the acquired first optical signal is a second direction perpendicular to the first direction, the guiding unit 2 guides the first optical signal in a second optical path shorter in the optical distance than the first optical path.

The demodulating unit 3 causes the first optical signal guided in the first optical path or the second optical path by the guiding unit 2 and the second optical signal branched by the branching unit 1 to interfere with each other thereby to demodulate the modulated signal, and outputs the demodulated signal to a subsequent stage. The polarization direction adjusting unit 4 judges a code error rate of the demodulated signal thereby to adjust the polarization direction of the first optical signal acquired by the guiding unit 2 in the first direction or the second direction.

As described above, the delayed interferometer according to the first embodiment guides the first optical signal which is one of the two branched modulated signals in an optical path having a different optical distance depending on the polarization direction, and adjusts the polarization direction of the first optical signal based on the code error rate of the modulated signal demodulated using the guided first optical signal. Therefore, the delayed interferometer according to the first embodiment can change the amount of delay of the modulated signal only by adjusting the polarization direction. Thus, the delayed interferometer according to the first embodiment can accurately change the amount of delay of the modulated signal as compared with the conventional technique involving a mechanical movement of an optical component.

### [b] Second Embodiment

Next, the delayed interferometer according to the first embodiment will be described with specific examples. In the second embodiment, there will be described an example in which the delayed interferometer described in the first embodiment is applied to an optical transmission system employing a DPSK system as modulation system.

A structure of an optical receiver including a delayed interferometer according to the second embodiment will be described first. FIG. 2 is a diagram illustrating the structure of an optical receiver 100 including a delayed interferometer 101 according to the second embodiment. The optical receiver 100 illustrated in FIG. 2 receives an optical signal phase-modulated by an optical transmitter (not illustrated) and uses the modulated signal received to perform various data processings. In the following, the optical signal phase-modulated by the optical transmitter will be called “modulated signal” simply.

As illustrated in FIG. 2, the optical receiver 100 includes the delayed interferometer 101, a receiver 102, and a bit judging device 103. The delayed interferometer 101 demodulates a modulated signal input from the optical transmitter to output a normal phase component and a reverse phase component of the demodulated signal which is the modulated signal demodulated to the receiver 102. The delayed interferometer 101 performs a processing of changing the amount of delay of the modulated signal based on the Bit Error Rate (BER) of the demodulated signal input from the bit judging device 103. The structure of the delayed interferometer 101 will be described later in detail.

The receiver 102 converts the normal phase component and the reverse phase component of the demodulated signal input from the delayed interferometer 101 into electric signals, respectively, and outputs a difference between the electric signal of the normal phase and the electric signal of the reverse phase, which are output, to the bit judging device 103.

The bit judging device 103 judges data based on the electric signals input from the receiver 102, and outputs the judged data to a subsequent device (not illustrated). The bit judging device 103 corrects an error of the judged data, and measures the number of data errors per unit time to output the measured number of data errors per unit time as the BER of the demodulated signal to the delayed interferometer 101.

A specific structure of the delayed interferometer 101 according to the second embodiment will be described. There will be described an example in which the delayed interferometer 101 according to the second embodiment is applied to a so-called Mach-Zehnder delayed interferometer.

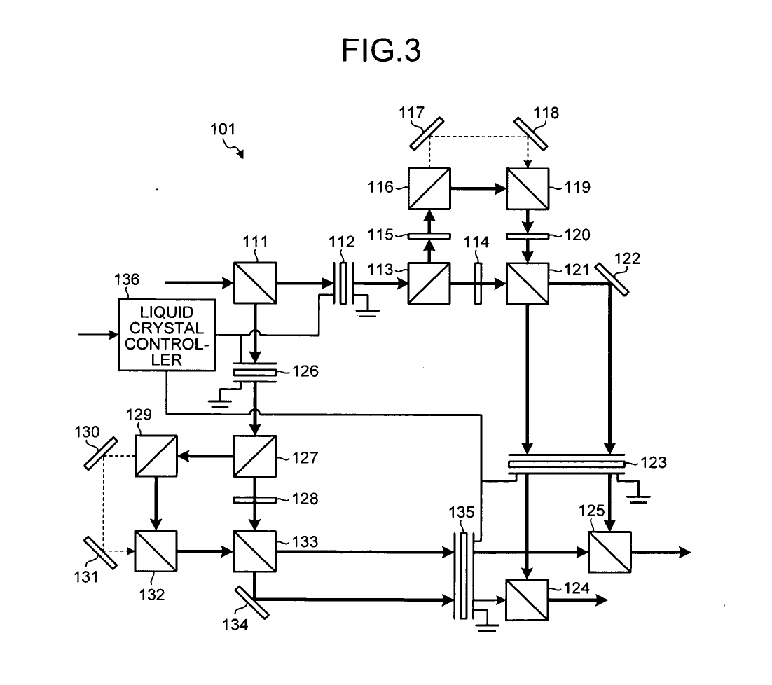

FIG. 3 is a diagram illustrating the structure of the delayed interferometer 101 according to the second embodiment. As illustrated, the delayed interferometer 101 according to the second embodiment includes a polarization beam splitter (PBS) 111, liquid crystal 112, and a beam splitter (BS) 113. The delayed interferometer 101 includes a phase adjustment device 114, a λ/2-wavelength plate 115, a PBS 116, a mirror 117, a mirror 118, a PBS 119, a λ/2-wavelength plate 120, a BS 121, a mirror 122, liquid crystal 123, a PBS 124, and a PBS 125. The delayed interferometer 101 further includes liquid crystal 126, a BS 127, a phase adjustment device 128, a PBS 129, a mirror 130, a mirror 131, a PBS 132, a BS 133, a mirror 134, liquid crystal 135, and a liquid crystal controller 136.

The PBS 111 branches the modulated signal input from the optical transmitter into a first modulated signal and a second modulated signal which are perpendicular to each other in the polarization direction to output the first modulated signal to the liquid crystal 112 and to output the second modulated signal to the liquid crystal 126. For example, the PBS 111 transmits a horizontal modulated signal which is a modulated signal whose polarization direction is horizontal among the modulated signals input from the optical transmitter as the first modulated signal to the liquid crystal 112, and reflects a vertical modulated signal which is a modulated signal whose polarization direction is vertical as the second modulated signal to the liquid crystal 126.

The liquid crystal 112 rotates the polarization direction of the first modulated signal input from the PBS 111 by 0° or 90°, and outputs the rotated first modulated signal to the BS 113. The liquid crystal 112 judges whether to rotate the polarization direction of the first modulated signal by 0° or 90° depending on a voltage applied from the liquid crystal controller 136 described later.

The BS 113 branches the first modulated signal input from the liquid crystal 112 into a first optical signal and a second optical signal to output the first optical signal to the λ/2-wavelength plate 115 and to output the second optical signal to the phase adjustment device 114. For example, the BS 113 reflects half of the first modulated signal input from the liquid crystal 112 as the first optical signal toward the λ/2-wavelength plate 115, and transmits the remaining half of the first modulated signal as the second optical signal to the phase adjustment device 114. The BS 113 is one example of the branching unit 1 according to the first embodiment.

The phase adjustment device 114 finely adjusts the length of the optical path of the second optical signal input from the BS 113 to output the finely-adjusted second optical signal to the BS 121 in order to change wavelengths strengthened in the delayed interferometer 101. For example, the phase adjustment device 114 controls a temperature of a medium such as glass, which varies in refraction index depending on the temperature, to finely adjust the length of the optical path of the second optical signal, and outputs the finely-adjusted second optical signal to the BS 121.

The λ/2-wavelength plate 115 rotates the polarization direction of the first optical signal input from the BS 113 by 90°, and outputs the rotated first modulated signal to the PBS 116. For example, when the polarization direction of the first optical signal input from the BS 113 is horizontal, the λ/2-wavelength plate 115 rotates the polarization direction of the first optical signal by 90°, and outputs the first optical signal whose polarization direction is vertical to the PBS 116.

The PBS 116 outputs the first optical signal to either the mirror 117 or the PBS 119 depending on the polarization direction of the first optical signal input from the λ/2-wavelength plate 115. Specifically, when the polarization direction of the first optical signal is horizontal, the PBS 116 transmits and outputs the first optical signal to the mirror 117. On the other hand, when the polarization direction of the first optical signal is vertical, the PBS 116 reflects and outputs the first optical signal to the PBS 119. The meaning of outputting the first optical signal to either the mirror 117 or the PBS 119 by the PBS 116 will be described later.

The mirror 117 reflects and outputs the first optical signal input from the PBS 116 to the mirror 118. The mirror 118 reflects and outputs the first optical signal input from the mirror 117 to the PBS 119.

The PBS 119 outputs the first optical signal input from the mirror 118 or the first optical signal input from the PBS 116 to the λ/2-wavelength plate 120. Specifically, since the polarization direction of the first optical signal input from the mirror 118 is horizontal, the PBS 119 transmits and outputs the first optical signal to the λ/2-wavelength plate 120. Since the polarization direction of the first optical signal input from the PBS 116 is vertical, the PBS 119 reflects and outputs the first optical signal to the λ/2-wavelength plate 120.

The λ/2-wavelength plate 120 rotates the polarization direction of the first optical signal input from the PBS 119 by 90°, and outputs the rotated first optical signal to the BS 121. For example, when the polarization direction of the first optical signal input from the PBS 119 is horizontal, the λ/2-wavelength plate 120 rotates the polarization direction of the first optical signal by 90°, and outputs the first optical signal whose polarization direction is vertical to the BS 121.

The meaning of outputting the first optical signal to either the mirror 117 or the PBS 119 by the PBS 116 will be described later. An optical path from the BS 113 through the λ/2-wavelength plate 115, the PBS 116, the mirror 117, the mirror 118, the PBS 119 and the λ/2-wavelength plate 120 to the BS 121 (which will be called “first optical path” below) is preset at an optical distance for delaying the first optical signal by one bit. On the other hand, an optical path from the BS 113 through the λ/2-wavelength plate 115, the PBS 116, the PBS 119 and the λ/2-wavelength plate 120 to the BS 121 (which will be called “second optical path” below) is preset at an optical distance shorter than that of the first optical path. Then, the PBS 116 outputs the first optical signal to either the mirror 117 or the PBS 119 depending on the polarization direction of the first optical signal as stated above. The first optical signal output to the mirror 117 by the PBS 116 is guided in the first optical path and thus is delayed by one bit. The first optical signal output to the PBS 119 by the PBS 116 is guided in the second optical path and thus is delayed by less than one bit. In other words, the PBS 116 outputs the first optical signal to the mirror 117 or the PBS 119 depending on the polarization direction of the first optical signal, and thus guides the first optical signal to the first optical path or the second optical path having a mutually different optical distance. Thus, the PBS 116 corresponds to one example of the guiding unit 2 according to the first embodiment.

The BS 121 causes the first optical signal input from the λ/2-wavelength plate 120 and the second optical signal input from the phase adjustment device 114 to interfere with each other to output the normal phase component of the interference signal as the interfered optical signal to the liquid crystal 123 and to output the reverse phase component of the interference signal to the mirror 122. The mirror 122 reflects and outputs the reverse phase component of the interference signal input from the BS 121 to the liquid crystal 123.

The liquid crystal 123 rotates the polarization direction of the normal phase component of the interference signal input from the BS 121 by 0° or 90°, and outputs the normal phase component of the rotated interference signal to the PBS 124. The liquid crystal 123 rotates the polarization direction of the reverse phase component of the interference signal input from the mirror 122 by 0° or 90°, and outputs the reverse phase component of the rotated interference signal to the PBS 125. The liquid crystal 123 rotates the polarization direction of the interference signal by 0° or 90° depending on the voltage applied from the liquid crystal controller 136.

The PBS 124 combines the normal phase component of the interference signal input from the liquid crystal 123 and the normal phase component of the interference signal input from the liquid crystal 135 described later in a state where the polarization directions are perpendicular to each other, and outputs the combined optical signal as the normal phase component of the demodulated signal to the receiver 102. The PBS 125 combines the reverse phase component of the interference signal input from the liquid crystal 123 and the reverse phase component of the interference signal input from the liquid crystal 135 described later in a state where the polarization directions are perpendicular to each other, and outputs the combined optical signal as the reverse phase component of the demodulated signal to the receiver 102. The BS 121, the mirror 122, the liquid crystal 123, the PBS 124 and the PBS 125 are examples of the demodulating unit 3 according to the first embodiment.

The liquid crystal 126 rotates the polarization direction of the second modulated signal input from the PBS 111 by 0° or 90°, and outputs the rotated second modulated signal to the BS 127. The liquid crystal 126 judges whether to rotate the polarization direction of the second modulated signal by 0° or 90° depending on the voltage applied from the liquid crystal controller 136 described later.

The BS 127 branches the second modulated signal input from the liquid crystal 126 into a first optical signal and a second optical signal to output the first optical signal to the PBS 129 and to output the second optical signal to the phase adjustment device 128. For example, the BS 127 reflects half of the second modulated signal input from the liquid crystal 126 as the first optical signal toward the PBS 129, and transmits the remaining half of the second modulated signal as the second optical signal to the phase adjustment device 128. The BS 127 is one example of the branching unit 1 according to the first embodiment.

Similar to the phase adjustment device 114, the phase adjustment device 128 finely adjusts the length of the optical path of the second optical signal input from the BS 127 and outputs the finely-adjusted second optical signal to the BS 133 in order to change wavelengths strengthened in the delayed interferometer 101.

The PBS 129 outputs the first optical signal to either the mirror 130 or the PBS 132 depending on the polarization direction of the first optical signal input from the BS 127. Specifically, when the polarization direction of the first optical signal is horizontal, the PBS 129 transmits and outputs the first optical signal to the mirror 130. On the other hand, when the polarization direction of the first optical signal is vertical, the PBS 129 reflects and outputs the first optical signal to the PBS 132. The meaning of outputting the first optical signal to the mirror 130 or the PBS 132 by the PBS 129 will be described later.

The mirror 130 reflects and outputs the first optical signal input from the PBS 129 to the mirror 131. The mirror 131 reflects and outputs the first optical signal input from the mirror 130 to the PBS 132.

The PBS 132 outputs the first optical signal input from the mirror 131 or the first optical signal input from the PBS 129 to the BS 133. Specifically, since the polarization direction of the first optical signal input from the mirror 131 is horizontal, the PBS 132 transmits and outputs the first optical signal to the BS 133. Since the polarization direction of the first optical signal input from the PBS 129 is vertical, the PBS 132 reflects and outputs the first optical signal to the BS 133.

The meaning of outputting the first optical signal to the mirror 130 or the PBS 132 by the PBS 129 will be described later. An optical path from the BS 127 through the PBS 129, the mirror 130, the mirror 131 and the PBS 132 to the BS 133 (which will be called “first optical path” below) is preset at an optical distance for delaying the first optical signal by one bit. On the other hand, an optical path from the BS 127 through the PBS 129 and the PBS 132 to the BS 133 (which will be called “second optical path” below) is preset at an optical distance shorter than that of the first optical path. Then, the PBS 129 outputs the first optical signal to either the mirror 130 or the PBS 132 depending on the polarization direction of the input first optical signal as stated above. The first optical signal output to the mirror 130 by the PBS 129 is guided in the first optical path and thus is delayed by one bit. The second optical signal output to the PBS 132 by the PBS 129 is guided in the second optical signal and thus is delayed by less than one bit. In other words, the PBS 129 outputs the first optical signal to the mirror 130 or the PBS 132 depending on the polarization direction of the input first optical signal, and thus guides the first optical signal to the first optical path or the second optical path having a mutually different optical distance. Therefore, the PBS 129 corresponds to one example of the guiding unit 2 according to the first embodiment.

The BS 133 causes the first optical signal input from the PBS 132 and the second optical signal input from the phase adjustment device 128 to interfere with each other to output the normal phase component of the interference signal as the interfered optical signal to the mirror 134 and to output the reverse phase component of the interference signal to the liquid crystal 135. The mirror 134 reflects and outputs the normal phase component of the interference signal input from the BS 133 to the liquid crystal 135.

The liquid crystal 135 rotates the normal phase component of the interference signal input from the mirror 134 by 0° or 90°, and outputs the normal phase component of the rotated interference signal to the PBS 124. The liquid crystal 135 rotates the polarization direction of the reverse phase component of the interference signal input from the BS 133 by 0° or 90°, and outputs the reverse phase component of the rotated interference signal to the PBS 125. The liquid crystal 135 rotates the polarization direction of the interference signal by 0° or 90° depending on the voltage applied from the liquid crystal controller 136 described later. The BS 133, the mirror 134, the liquid crystal 135, the PBS 124 and the PBS 125 are examples of the demodulating unit 3 according to the first embodiment.

The liquid crystal controller 136 judges the BER of the demodulated signal input from the bit judging device 103 to control the liquid crystal 112, 126, and adjusts the polarization direction of the first optical signal input into the PBS 116, 129 in the horizontal direction or the vertical direction. The liquid crystal controller 136 is one example of the polarization direction adjusting unit 4 according to the first embodiment.

A processing of adjusting the polarization direction by the liquid crystal controller 136 will be specifically described. In the following, it is assumed that the PBS 111 outputs the horizontal modulated signal as the first modulated signal to the liquid crystal 112 and outputs the vertical modulated signal as the second modulated signal to the liquid crystal 126. The liquid crystal 112 rotates the polarization direction of the horizontal modulated signal input from the PBS 111 by 90° to be vertical, and outputs the rotated vertical modulated signal to the BS 113. The liquid crystal 126 rotates the polarization direction of the vertical modulated signal input from the PBS 111 by 90° to be horizontal, and outputs the rotated horizontal modulated signal to the BS 127.

Under the situation, the BS 113 branches the vertical modulated signal input from the liquid crystal 112 into a first optical signal and a second optical signal, and outputs the first optical signal to the λ/2-wavelength plate 115. The λ/2-wavelength plate 115 rotates the polarization direction of the first optical signal input from the BS 113 by 90° to be horizontal, and outputs the rotated first optical signal to the PBS 116. Since the polarization direction of the first optical signal input from the λ/2-wavelength plate 115 is horizontal, the PBS 116 transmits and outputs the first optical signal to the mirror 117. The mirror 117 reflects and outputs the first optical signal input from the PBS 116 to the mirror 118. The mirror 118 reflects and outputs the first optical signal input from the mirror 117 to the PBS 119. Since the polarization direction of the first optical signal input from the mirror 118 is horizontal, the PBS 119 transmits and outputs the first optical signal to the λ/2-wavelength plate 120. Since the polarization direction of the first optical signal input from the PBS 119 is horizontal, the λ/2-wavelength plate 120 rotates the polarization direction of the first optical direction by 90° to be vertical, and outputs the first optical signal whose polarization direction is vertical to the BS 121. In other words, the first optical signal output to the mirror 117 by the PBS 116 is guided in the first optical path and thus is delayed by one bit.

On the other hand, the BS 127 branches the horizontal modulated signal input from the liquid crystal 126 into a first optical signal and a second optical signal to output the first optical signal to the PBS 129. Since the polarization direction of the first optical signal input from the BS 127 is horizontal, the PBS 129 transmits and outputs the first optical signal to the mirror 130. The mirror 130 reflects and outputs the first optical signal input from the PBS 129 to the mirror 131. The mirror 131 reflects and outputs the first optical signal input from the mirror 130 to the PBS 132. Since the polarization direction of the first optical signal input from the mirror 131 is horizontal, the PBS 132 transmits and outputs the first optical signal to the BS 133. In other words, the first optical signal output to the mirror 130 by the PBS 129 is guided in the first optical path and thus is delayed by one bit.

Then, the liquid crystal controller 136 judges whether a variation of the BER of the demodulated signal input from the bit judging device 103 is a predetermined threshold or more. A factor of the variation of the BER of the demodulated signal may assume that an external device such as interleaver is additionally arranged on a transmission path upstream of the delayed interferometer 101, for example. When it is determined that the variation of the BER of the demodulated signal is smaller than the predetermined threshold, the liquid crystal controller 136 does not perform the processing of adjusting the polarization direction.

On the other hand, when it is determined that the variation of the BER of the demodulated signal is the predetermined threshold or more, the liquid crystal controller 136 applies a voltage to the liquid crystal 112 and the liquid crystal 126. When being applied the voltage from the liquid crystal controller 136, the liquid crystal 112 rotates the polarization direction of the horizontal modulated signal input from the PBS 111 by 0°, and outputs the rotated horizontal modulated signal to the BS 113. In other words, when being applied the voltage from the liquid crystal controller 136, the liquid crystal 112 maintains the polarization direction of the horizontal modulated signal input from the PBS 111 in the horizontal direction as is, and outputs the horizontal modulated signal to the BS 113. The BS 113 branches the horizontal modulated signal input from the liquid crystal 112 into a first optical signal and a second optical signal and outputs the first optical signal to the λ/2-wavelength plate 115. The λ/2-wavelength plate 115 rotates the polarization direction of the first optical signal input from the BS 113 by 90° to be vertical, and outputs the rotated first optical signal to the PBS 116. Since the polarization direction of the first optical signal input from the λ/2-wavelength plate 115 is vertical, the PBS 116 reflects and outputs the first optical signal to the PBS 119. Since the polarization direction of the first optical signal input from the PBS 116 is vertical, the PBS 119 reflects and outputs the first optical signal to the λ/2-wavelength plate 120. Since the polarization direction of the first optical signal input from the PBS 119 is vertical, the λ/2-wavelength plate 120 rotates the polarization direction of the first optical signal by 90° to be horizontal, and outputs the first optical signal whose polarization direction is horizontal to the BS 121. In other words, the first optical signal output to the PBS 119 by the PBS 116 is guided in the second optical path and thus is delayed by less than one bit.

On the other hand, when being applied the voltage from the liquid crystal controller 136, the liquid crystal 126 rotates the polarization direction of the vertical modulated signal input from the PBS 111 by 0°, and outputs the rotated vertical modulated signal to the BS 127. In other words, when being applied the voltage from the liquid crystal controller 136, the liquid crystal 126 maintains the polarization direction of the vertical modulated signal input from the PBS 111 in the vertical direction as is, and outputs the vertical modulated signal to the BS 127. The BS 127 branches the vertical modulated signal input from the liquid crystal 126 into a first optical signal and a second optical signal and outputs the first optical signal to the PBS 129. Since the polarization direction of the first optical signal input from the BS 127 is vertical, the PBS 129 reflects and outputs the first optical signal to the PBS 132. Since the polarization direction of the first optical signal input from the PBS 129 is vertical, the PBS 132 reflects and outputs the first optical signal to the BS 133. In other words, the first optical signal output to the PBS 132 by the PBS 129 is guided in the second optical path and thus is delayed by less than one bit.

The liquid crystal controller 136 controls the liquid crystal 123 to adjust the polarization directions of the normal phase component and the reverse phase component of the interference signal output from the liquid crystal 123 to the PBS 124 and the PBS 125 in the vertical direction. The liquid crystal controller 136 controls the liquid crystal 135 to adjust the polarization directions of the normal phase component and the reverse phase component of the interference signal output from the liquid crystal 135 to the PBS 124 and the PBS 125 in the horizontal direction. Thus, the PBS 124 and the PBS 125 can output the normal phase component and the reverse phase component of the demodulated signal in certain directions, respectively, thereby sharing the output port.

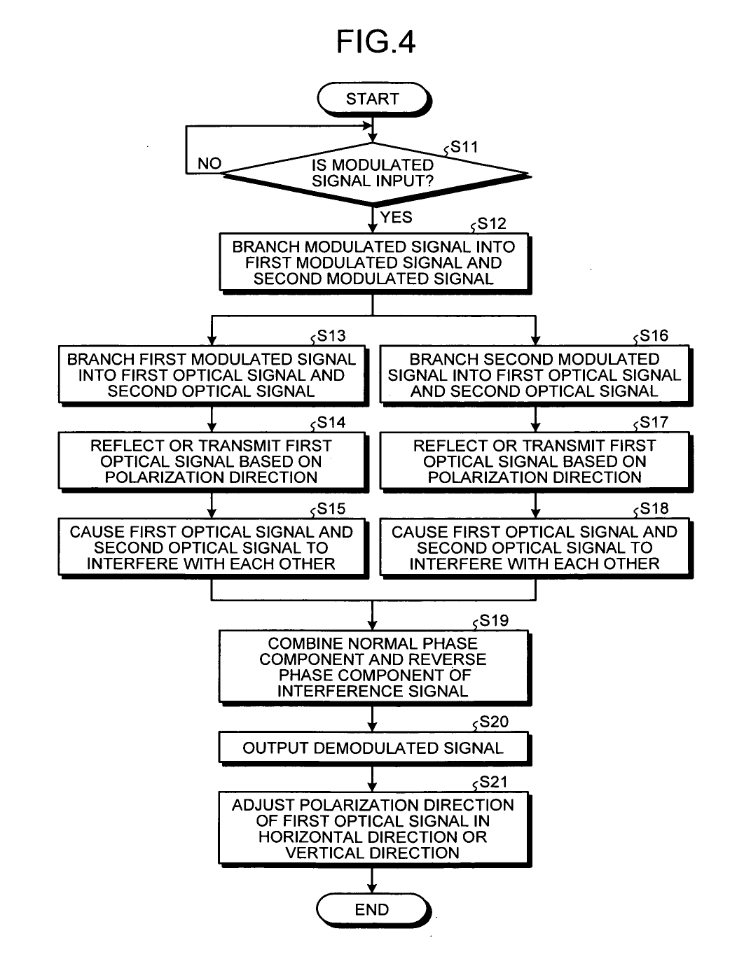

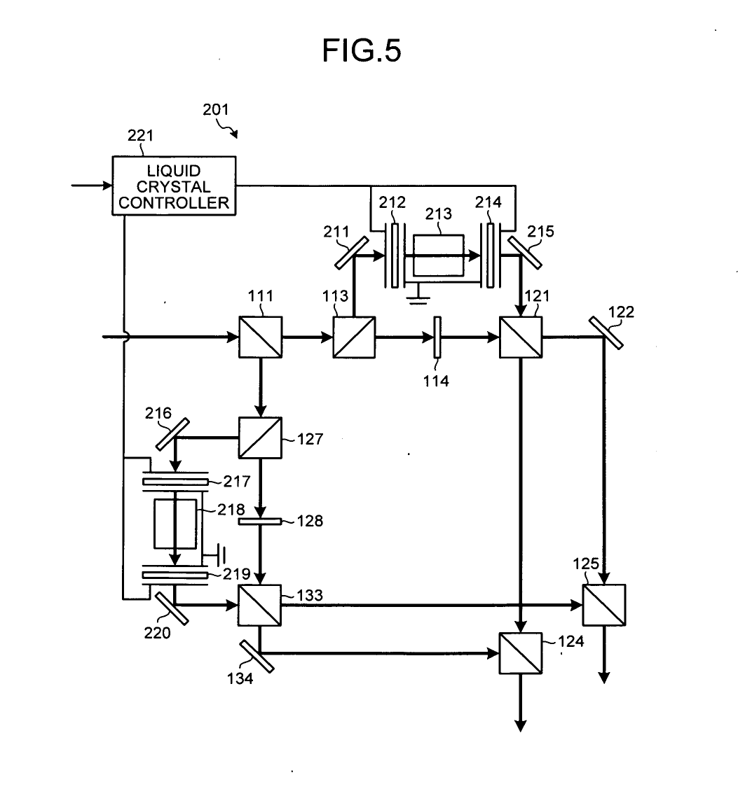

A processing procedure by the delayed interferometer 101 according to the second embodiment will be described below. FIG. 4 is a flowchart illustrating the processing procedure by the delayed interferometer 101 according to the second embodiment. As illustrated, the delayed interferometer 101 waits until a modulated signal is input from the optical transmitter (step S11: No). When the modulated signal is input from the optical transmitter (step S11: Yes), the PBS 111 of the delayed interferometer 101 branches the modulated signal into a first modulated signal and a second modulated signal which are perpendicular to each other in the polarization direction (step S12). The first modulated signal branched by the PBS 111 is input into the BS 113 via the liquid crystal 112 and the second modulated signal is input into the BS 127 via the liquid crystal 126.

Then, the BS 113 branches the first modulated signal input from the liquid crystal 112 into a first optical signal and a second optical signal (step S13). The first optical signal branched by the BS 113 is input into the PBS 116 via the λ/2-wavelength plate 115 and the second optical signal is input into the BS 121 via the phase adjustment device 114.

Subsequently, the PBS 116 transmits or reflects the first optical signal depending on the polarization direction of the first optical signal input from the λ/2-wavelength plate 115 (step S14). Specifically, when the polarization direction of the first optical signal is horizontal, the PBS 116 transmits and outputs the first optical signal to the mirror 117. On the other hand, when the polarization direction of the first optical signal is vertical, the PBS 116 reflects and outputs the first optical signal to the PBS 119. The first optical signal output to the mirror 117 by the PBS 116 is guided in the first optical path, leading to the BS 121, and consequently the first optical signal is delayed by one bit. The first optical signal output to the PBS 119 by the PBS 116 is guided in the second optical path, leading to the BS 121, and consequently the first optical signal is delayed by less than one bit.

Subsequently, the BS 121 causes the first optical signal guided in the first optical path or the second optical path by the PBS 116 and the second optical signal input from the phase adjustment device 114 to interfere with each other (step S15). The normal phase component of the interference signal output from the BS 121 is input into the PBS 124 via the liquid crystal 123 and the reverse phase component of the interference signal is input into the PBS 125 via the mirror 122 and the liquid crystal 123.

The BS 127 branches the second modulated signal input from the liquid crystal 126 into a first optical signal and a second optical signal (step S16). The first optical signal branched by the BS 127 is input into the PBS 129 and the second optical signal is input into the BS 133 via the phase adjustment device 128.

Subsequently, the PBS 129 transmits or reflects the first optical signal depending on the polarization direction of the first optical signal input from the BS 127 (step S17). Specifically, when the polarization direction of the first optical signal is horizontal, the PBS 129 transmits and outputs the first optical signal to the mirror 130. On the other hand, when the polarization direction of the first optical signal is vertical, the PBS 129 reflects and outputs the first optical signal to the PBS 132. The first optical signal output to the mirror 130 by the PBS 129 is guided in the first optical path, leading to the BS 133, and consequently the first optical signal is delayed by one bit. The first optical signal output to the PBS 132 by the PBS 129 is guided in the second optical path, leading to the BS 133, and consequently the first optical signal is delayed by less than one bit.

Subsequently, the BS 133 causes the first optical signal guided in the first optical path or the second optical path by the PBS 129 and the second optical signal input from the phase adjustment device 128 to interfere with each other (step S18). The normal phase component of the interference signal output from the BS 133 is input into the PBS 124 via the mirror 134 and the liquid crystal 135 and the reverse phase component of the interference signal is input into the PBS 125 via the liquid crystal 135.

Subsequently, the PBS 124 combines the normal phase component of the interference signal input from the liquid crystal 123 and the normal phase component of the interference signal input from the liquid crystal 135 in a state where the polarization directions are perpendicular to each other. Along with this, the PBS 125 combines the reverse phase component of the interference signal input from the liquid crystal 123 and the reverse phase component of the interference signal input from the liquid crystal 135 in a state where the polarization directions are perpendicular to each other (step S19). Then, the PBS 124 and the PBS 125 output the combined optical signals as the normal phase component and the reverse phase component of the demodulated signal to the receiver 102, respectively (step S20). The normal phase component and the reverse phase component of the demodulated signal output from the PBS 124 and the PBS 125 are input into the bit judging device 103 via the receiver 102. The bit judging device 103 measures the BER of the input demodulated signal and outputs it to the liquid crystal controller 136 of the delayed interferometer.

Subsequently, the liquid crystal controller 136 judges the BER of the demodulated signal input from the bit judging device 103 to control the liquid crystal 112 and the liquid crystal 126, and adjusts the polarization direction of the first optical signal input into the PBS 116, 129 in the horizontal direction or the vertical direction (step S21).

As described above, the delayed interferometer 101 according to the second embodiment branches the modulated signal into the first modulated signal and the second modulated signal which are perpendicular to each other in the polarization direction, and guides the first optical signal which is one of the two branched modulated signals to an optical path having a different optical distance depending on the polarization direction of the first optical signal. For example, when the polarization direction of the first optical signal is horizontal, the delayed interferometer 101 guides the first optical signal in the first optical path from the BS 113 through the λ/2-wavelength plate 115, the PBS 116, the mirror 117, the mirror 118, the PBS 119 and the λ/2-wavelength plate 120 to the BS 121. On the other hand, when the polarization direction of the first optical signal is vertical, the delayed interferometer 101 guides the first optical signal in the second optical path from the BS 113 through the λ/2-wavelength plate 115, the PBS 116, the PBS 119 and the λ/2-wavelength plate 120 to the BS 121. Then, the delayed interferometer 101 uses the first optical signal guided in the first optical path or the second optical path to demodulate the modulated signal, and adjusts the polarization direction of the first optical signal in the horizontal direction or the vertical direction based on the BER of the demodulated signal. Thus, the delayed interferometer 101 according to the second embodiment can change the amount of delay of the modulated signal from one bit to less than one bit only by adjusting the polarization direction. Consequently, the delayed interferometer 101 can accurately change the amount of delay of the modulated signal as compared with the conventional technique involving a mechanical movement of an optical component.

The amount of delay of the modulated signal in the delayed interferometer and a free spectral range (FSR) of the delayed interferometer have an inversely proportional relationship. Thus, the delayed interferometer 101 reduces the amount of delay of the modulated signal from one bit to less than one bit and thus can increase the FSR.

The delayed interferometer 101 controls the liquid crystal 112 and the liquid crystal 126 for rotating the polarization direction of the input optical signal by 0° or 90° to adjust the polarization direction of the first optical signal in the horizontal direction or the vertical direction. Thereby, the delayed interferometer 101 can adjust the polarization direction of the first optical signal only by performing a simple processing of applying a voltage to the liquid crystal 112 and the liquid crystal 126, thereby rapidly changing the amount of delay of the modulated signal.

The delayed interferometer 101 uses the PBS 116 and the PBS 129 for reflecting or transmitting the optical signal depending on the polarization direction of the input optical signal to guide the first optical signal in the first optical path or the second optical path. Therefore, the delayed interferometer 101 can use the existing optical components such as PBS to easily guide the first optical signal in the first optical path or the second optical path.

### [c] Third Embodiment

The second embodiment describes the example in which the PBS 116 and the PBS 129 are used to reflect or transmit the first optical signal, thereby guiding the first optical signal to either one of the two optical paths which are different from each other in the optical distance. However, an optical component other than PBS may be used to guide the first optical signal to either one of the two optical paths which are different from each other in the optical distance. The third embodiment describes an example in which optical components other than PBS are used to guide the first optical signal to either one of the two optical paths which are different from each other in the optical distance.

FIG. 5 is a diagram illustrating a structure of a delayed interferometer 201 according to the third embodiment. In the following, like reference numerals are denoted to sites having the similar functions to the constituents illustrated in FIG. 3, and a detailed explanation thereof will be omitted. A structure of an optical receiver including the delayed interferometer 201 according to the third embodiment is similar to the structure illustrated in FIG. 2 and the explanation thereof will be omitted.

As illustrated in FIG. 5, the delayed interferometer 201 includes liquid crystal 212 and liquid crystal 214 instead of the liquid crystal 112 illustrated in FIG. 3. The delayed interferometer 201 includes a mirror 211, a birefringence medium 213 and a mirror 215 instead of the λ/2-wavelength plate 115, the PBS 116, the mirror 117, the mirror 118, the PBS 119 and the λ/2-wavelength plate 120 illustrated in FIG. 3. The delayed interferometer 201 includes liquid crystal 217 and liquid crystal 219 instead of the liquid crystal 126 illustrated in FIG. 3. The delayed interferometer 201 includes a mirror 216, a birefringence medium 218 and a mirror 220 instead of the PBS 129, the mirror 130, the mirror 131 and the PBS 132 illustrated in FIG. 3. The delayed interferometer 201 includes a liquid crystal controller 221 instead of the liquid crystal controller 136 illustrated in FIG. 3. The delayed interferometer 201 omits the constituents corresponding to the liquid crystal 123 and the liquid crystal 135 illustrated in FIG. 3.

The mirror 211 reflects and outputs the first optical signal input from the BS 113 to the liquid crystal 212. The liquid crystal 212 rotates the polarization direction of the first optical signal input from the mirror 211 by 0° or 90°, and outputs the rotated first optical signal to the birefringence medium 213. The liquid crystal 212 judges whether to rotate the polarization direction of the first optical signal by 0° or 90° depending on the voltage applied from the liquid crystal controller 221 described later.

The birefringence medium 213 is directed for refracting an optical signal in one of a plurality of paths each of the plurality of paths has a different optical distance respectively depending on the polarization direction of the input optical signal, and is of calcite, rutile or YVO₄, for example. The birefringence medium 213 is arranged to be sandwiched between the liquid crystal 212 and the liquid crystal 214. The birefringence medium 213 refracts the first optical signal in one of a plurality of paths each of the plurality of paths has a different optical distance respectively depending on the polarization direction of the first optical signal input from the liquid crystal 212 and outputs the refracted first optical signal to the liquid crystal 214. Specifically, when the polarization direction of the first optical signal is horizontal, the birefringence medium 213 refracts the first optical signal in a path having a maximum optical distance (which will be called “maximum path” below). When the polarization direction of the first optical signal is vertical, the birefringence medium 213 refracts the first optical signal in a path having a minimum optical distance (which will be called “minimum path” below). The birefringence medium 213 outputs the first optical signal refracted in the maximum path or the minimum path to the liquid crystal 214. The meaning of refracting the first optical signal in the maximum path or the minimum path by the birefringence medium 213 will be described below.

The liquid crystal 214 rotates the polarization direction of the first optical signal input from the liquid crystal 212 via the birefringence medium 213 by 0° or 90° and outputs the rotated first optical signal to the mirror 215. Specifically, when the polarization direction of the first optical signal is rotated by 0° by the liquid crystal 212, that is, when the polarization direction of the first optical signal is maintained in the horizontal direction as is the liquid crystal 214 rotates the polarization direction of the first optical signal input from the liquid crystal 212 by 0°. On the other hand, when the polarization direction of the first optical signal is rotated by 90° by the liquid crystal 212, that is, when the polarization direction of the first optical signal is rotated from the horizontal direction to the vertical direction, the liquid crystal 214 rotates the polarization direction of the first optical signal input from the liquid crystal 212 by 90° to return to the horizontal direction. Then, the liquid crystal 214 outputs the rotated first optical signal to the mirror 215. The liquid crystal 214 judges whether to rotate the polarization direction of the first optical signal by 0° or 90° depending on the voltage applied from the liquid crystal controller 221. The mirror 215 outputs the first optical signal input from the liquid crystal 214 to the BS 121.

The meaning of refracting the first optical signal in the maximum path or the minimum path by the birefringence medium 213 will be described herein. An optical path from the BS 113 through the mirror 211, the liquid crystal 212, the maximum path of the birefringence medium 213, the liquid crystal 214 and the mirror 215 to the BS 121 (which will be called “first optical path” below) is preset at an optical distance for delaying the first optical signal by one bit. On the other hand, an optical path from the BS 113 through the mirror 211, the liquid crystal 212, the minimum path of the birefringence medium 213, the liquid crystal 214 and the mirror 215 to the BS 121 (which will be called “second optical path” below) is preset at an optical distance shorter than that of the first optical path. Then, the birefringence medium 213 refracts the first optical signal in the maximum path or the minimum path depending on the polarization direction of the first optical signal and outputs the first optical signal refracted in the maximum path or the minimum path to the liquid crystal 214 as stated above. The first optical signal refracted in the maximum path by the birefringence medium 213 is guided in the first optical path and thus is delayed by one bit. The first optical signal refracted in the minimum path by the birefringence medium 213 is guided in the second optical path and thus is delayed by less than one bit. In other words, the birefringence medium 213 refracts the first optical signal in the maximum path or the minimum path depending on the polarization direction of the first optical signal and thus guides the first optical signal to the first optical path or the second optical path having a mutually different optical distance. Thus, the birefringence medium 213 corresponds to one example of the guiding unit 2 according to the first embodiment.

The mirror 216 reflects and outputs the first optical signal input from the BS 127 to the liquid crystal 217. The liquid crystal 217 rotates the polarization direction of the first optical signal input from the mirror 216 by 0° or 90°, and outputs the rotated first optical signal to the birefringence medium 218. The liquid crystal 217 judges whether to rotate the polarization direction of the first optical signal by 0° or 90° depending on the voltage applied from the liquid crystal controller 221.

The birefringence medium 218 refracts an optical signal in a path having a different optical distance depending on the polarization direction of the input optical signal, and is of calcite, rutile or YVO₄, for example. The birefringence medium 218 is arranged to be sandwiched between the liquid crystal 217 and the liquid crystal 219. The birefringence medium 218 refracts the first optical signal in a path having a different optical distance depending on the polarization direction of the first optical signal input from the liquid crystal 217, and outputs the refracted first optical signal to the liquid crystal 219. Specifically, when the polarization direction of the first optical signal is vertical, the birefringence medium 218 refracts the first optical signal in the maximum path. When the polarization direction of the first optical signal is horizontal, the birefringence medium 218 refracts the first optical signal in the minimum path. The meaning of refracting the first optical signal in the maximum path or the minimum path by the birefringence medium 218 will be described later.

The liquid crystal 219 rotates the polarization direction of the first optical signal input from the liquid crystal 217 via the birefringence medium 218 by 0° or 90°, and outputs the rotated first optical signal to the mirror 220. Specifically, when the polarization direction of the first optical signal is rotated by 0° by the liquid crystal 217, that is, when the polarization direction of the first optical signal is maintained in the vertical direction as is, the liquid crystal 219 rotates the polarization direction of the first optical signal input from the liquid crystal 217 by 0°. On the other hand, when the polarization direction of the first optical signal is rotated by 90° by the liquid crystal 217, that is, when the polarization direction of the first optical signal is rotated from the vertical direction to the horizontal direction, the liquid crystal 219 rotates the polarization direction of the first optical signal input from the liquid crystal 217 by 90° to return to the vertical direction. Then, the liquid crystal 219 outputs the rotated first optical signal to the mirror 220. The liquid crystal 219 judges whether to rotate the polarization direction of the first optical direction by 0° or 90° depending on the voltage applied from the liquid crystal controller 221. The mirror 220 outputs the first optical signal input from the liquid crystal 219 to the BS 133.

The meaning of refracting the first optical signal in the maximum path or the minimum path by the birefringence medium 218 will be described herein. An optical path from the BS 127 through the mirror 216, the liquid crystal 217, the maximum path of the birefringence medium 218, the liquid crystal 219 and the mirror 220 to the BS 133 (which will be called “first optical path” below) is preset at an optical distance for delaying the first optical signal by one bit. On the other hand, an optical path from the BS 127 through the mirror 216, the liquid crystal 217, the minimum path of the birefringence medium 218, the liquid crystal 219 and the mirror 220 to the BS 133 (which will be called “second optical path” below) is preset at an optical distance shorter than that of the first optical path. The birefringence medium 218 refracts the first optical signal in the maximum path or the minimum path depending on the polarization direction of the first optical signal and outputs the first optical signal refracted in the maximum path or the minimum path to the liquid crystal 219. The first optical signal refracted in the maximum path by the birefringence medium 218 is guided in the first optical path and thus is delayed by one bit. The first optical signal refracted in the minimum path by the birefringence medium 218 is guided in the second optical path and thus is delayed by less than one bit. In other words, the birefringence medium 218 refracts the first optical signal in the maximum path or the minimum path depending on the polarization direction of the first optical signal and guides the first optical signal to the first optical path or the second optical path having a mutually different optical distance. Thereby, the birefringence medium 218 corresponds to one example of the guiding unit 2 according to the first embodiment.

The liquid crystal controller 221 judges the BER of the demodulated signal input from the bit judging device 103 to control the liquid crystal 212, 214, 217, 219, and adjusts the polarization direction of the first optical signal input into the birefringence medium 213, 218 in the horizontal direction or the vertical direction. The liquid crystal controller 221 is one example of the polarization direction adjusting unit 4 according to the first embodiment.

A processing of adjusting the polarization direction by the liquid crystal controller 221 will be specifically described herein. In the following, it is assumed that the PBS 111 outputs the horizontal modulated signal as the first modulated signal to the BS 113 and outputs the vertical modulated signal as the second modulated signal to the BS 127. Further, it is assumed that the liquid crystal 212 rotates the polarization direction of the first optical signal input from the mirror 211 by 0° and outputs the rotated first optical signal to the birefringence medium 213. It is assumed that the liquid crystal 214 rotates the polarization direction of the first optical signal input from the liquid crystal 212 via the birefringence medium 213 by 0° and outputs the rotated first optical signal to the mirror 215. It is assumed that the liquid crystal 217 rotates the polarization direction of the first optical signal input from the mirror 216 by 0° and outputs the rotated first optical signal to the birefringence medium 218. Furthermore, it is assumed that the liquid crystal 219 rotates the polarization direction of the first optical signal input from the liquid crystal 217 via the birefringence medium 218 by 0°, and outputs the rotated first optical signal to the mirror 220.

Under the situation, the BS 113 branches the horizontal modulated signal input from the PBS 111 into a first optical signal and a second optical signal and outputs the first optical signal to the mirror 211. The mirror 211 reflects and outputs the first optical signal input from the BS 113 to the liquid crystal 212. The liquid crystal 212 maintains the polarization direction of the first optical signal input from the mirror 211 in the horizontal direction as is and outputs the first optical signal to the birefringence medium 213. Since the polarization direction of the first optical signal input from the liquid crystal 212 is horizontal, the birefringence medium 213 refracts the first optical signal in the maximum path and outputs the refracted first optical signal to the liquid crystal 214. The liquid crystal 214 maintains the polarization direction of the first optical signal input from the birefringence medium 213 in the horizontal direction as is and outputs the first optical signal to the mirror 215. The mirror 215 reflects and outputs the first optical signal input from the liquid crystal 214 to the BS 121. In other words, the first optical signal refracted in the maximum path by the birefringence medium 213 is guided in the first optical path and thus is delayed by one bit.

On the other hand, the BS 127 branches the vertical modulated signal input from the PBS 111 into a first optical signal and a second optical signal and outputs the first optical signal to the mirror 216. The mirror 216 reflects and outputs the first optical signal input from the BS 127 to the liquid crystal 217. The liquid crystal 217 maintains the polarization direction of the first optical signal input from the mirror 216 in the vertical direction as is, and outputs the first optical signal to the birefringence medium 218. Since the polarization direction of the first optical signal input from the liquid crystal 217 is vertical, the birefringence medium 218 refracts the first optical signal in the maximum path and outputs the refracted first optical signal to the liquid crystal 219. The liquid crystal 219 maintains the polarization direction of the first optical signal input from the birefringence medium 218 in the vertical direction as is, and outputs the first optical signal to the mirror 220. The mirror 220 reflects and outputs the first optical signal input from the liquid crystal 219 to the BS 133. In other words, the first optical signal refracted in the maximum path by the birefringence medium 218 is guided in the first optical path and thus is delayed by one bit.

Then, the liquid crystal controller 221 judges whether the variation of the BER of the demodulated signal input from the bit judging device 103 is the predetermined threshold or more. A factor of the variation of the BER of the demodulated signal may assume that an external device such as interleaver is additionally arranged on a transmission path upstream of the delayed interferometer 201, for example. When it is determined that the variation of the BER of the demodulated signal is smaller than the predetermined threshold, the liquid crystal controller 221 does not perform the processing of adjusting the polarization direction.

On the other hand, when it is determined that the variation of the BER of the demodulated signal is the predetermined threshold or more, the liquid crystal controller 221 stops applying the voltage to the liquid crystal 212, 214, 217, 219. When the voltage stops being applied from the liquid crystal controller 221, the liquid crystal 212 rotates the polarization direction of the first optical signal input from the mirror 211 by 90° to be vertical, and outputs the rotated first optical signal to the birefringence medium 213. Since the polarization direction of the first optical signal input from the liquid crystal 212 is vertical, the birefringence medium 213 refracts the first optical signal in the minimum path and outputs the refracted first optical signal to the liquid crystal 214. When the voltage stops being applied from the liquid crystal controller 221, the liquid crystal 214 rotates the polarization direction of the first optical signal input from the birefringence medium 213 by 90° to return to the horizontal direction, and outputs the rotated first optical signal to the mirror 215. The mirror 215 reflects and outputs the first optical signal input from the liquid crystal 214 to the BS 121. In other words, the first optical signal refracted in the minimum path by the birefringence medium 213 is guided in the second optical path and thus is delayed by less than one bit.

On the other hand, when the voltage stops being applied from the liquid crystal controller 221, the liquid crystal 217 rotates the polarization direction of the first optical signal input from the mirror 216 by 90° to be horizontal and outputs the rotated first optical signal to the birefringence medium 218. Since the polarization direction of the first optical signal input from the liquid crystal 217 is horizontal, the birefringence medium 218 refracts the first optical signal in the minimum path and outputs the refracted first optical signal to the liquid crystal 219. When the voltage stops being applied from the liquid crystal controller 221, the liquid crystal 219 rotates the polarization direction of the first optical signal input from the birefringence medium 218 by 90° to return to the vertical direction, and outputs the rotated first optical signal to the mirror 220. The mirror 220 reflects and outputs the first optical signal input from the liquid crystal 219 to the BS 133. In other words, the first optical signal refracted in the minimum path by the birefringence medium 218 is guided in the second optical path and thus is delayed by less than one bit.

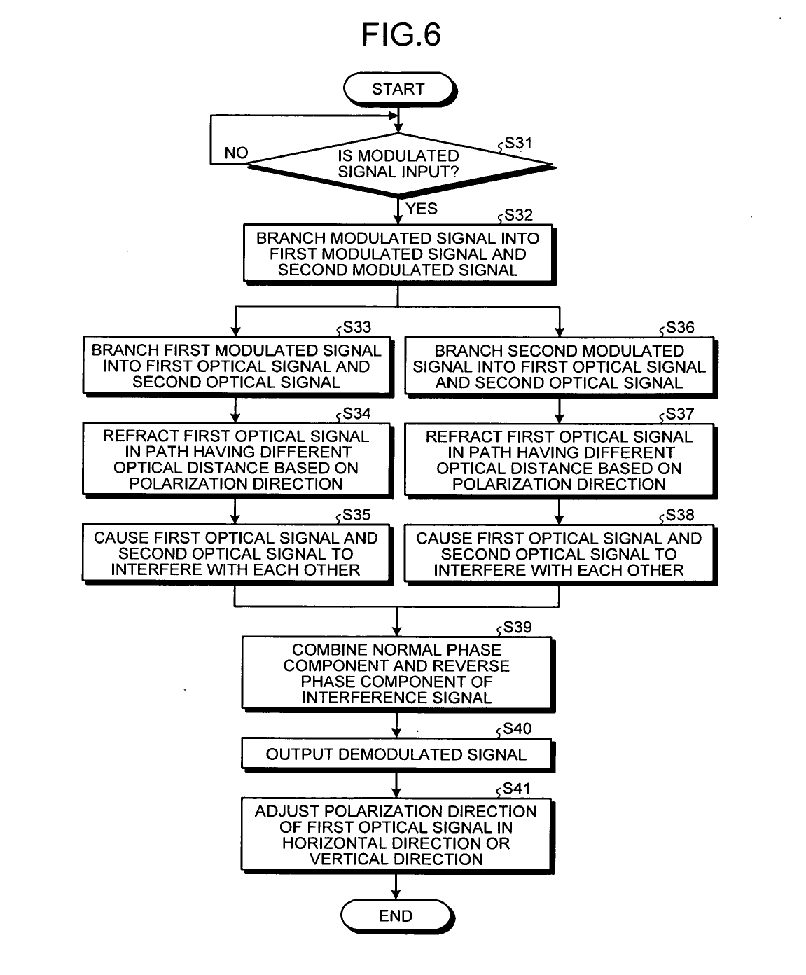

A processing procedure by the delayed interferometer 201 according to the third embodiment will be described below. FIG. 6 is a flowchart illustrating the processing procedure by the delayed interferometer 201 according to the third embodiment. As illustrated, the delayed interferometer 201 waits until a modulated signal is input from the optical transmitter (step S31: No). When the modulated signal is input from the optical transmitter (step S31: Yes), the PBS 111 of the delayed interferometer 201 branches the modulated signal into a first modulated signal and a second modulated signal which are perpendicular to each other in the polarization direction (step S32). The first modulated signal branched by the PBS 111 is input into the BS 113 and the second modulated signal is input into the BS 127.

Then, the BS 113 branches the first modulated signal input from the PBS 111 into a first optical signal and a second optical signal (step S33). The first optical signal branched by the BS 113 is input into the birefringence medium 213 via the mirror 211 and the liquid crystal 212 and the second optical signal is input into the BS 121 via the phase adjustment device 114.

Subsequently, the birefringence medium 213 refracts the first optical signal in a path having a different optical distance depending on the polarization direction of the first optical signal input from the liquid crystal 212 (step S34). Specifically, when the polarization direction of the first optical signal is horizontal, the birefringence medium 213 refracts the first optical signal in the maximum path. On the other hand, when the polarization direction of the first optical signal is vertical, the birefringence medium 213 refracts the first optical signal in the minimum path. The first optical signal refracted in the maximum path by the birefringence medium 213 is guided in the first optical path, leading to the BS 121, and consequently the first optical signal is delayed by one bit. The first optical signal refracted in the minimum path by the birefringence medium 213 is guided in the second optical path, leading to the BS 121, and consequently the first optical signal is delayed by less than one bit.

Subsequently, the BS 121 causes the first optical signal guided in the first optical path or the second optical path by the birefringence medium 213 and the second optical signal input from the phase adjustment device 114 to interfere with each other (step S35). The normal phase component of the interference signal output from the BS 121 is input into the PBS 124 and the reverse phase component of the interference signal is input into the PBS 125 via the mirror 122.

The BS 127 branches the second modulated signal input from the PBS 111 into a first optical signal and a second optical signal (step S36). The first optical signal branched by the BS 127 is input into the birefringence medium 218 via the mirror 216 and the liquid crystal 217 and the second optical signal is input into the BS 133 via the phase adjustment device 128.

Subsequently, the birefringence medium 218 refracts the first optical signal in a path having a different optical distance depending on the polarization direction of the first optical signal input from the liquid crystal 217 (step S37). Specifically, when the polarization direction of the first optical signal is vertical, the birefringence medium 218 refracts the first optical signal in the maximum path. On the other hand, when the polarization direction of the first optical signal is horizontal, the birefringence medium 218 refracts the first optical signal in the minimum path. The first optical signal refracted in the maximum path by the birefringence medium 218 is guided in the first optical path, leading to the BS 133, and consequently the first optical signal is delayed by one bit. The first optical signal refracted in the minimum path by the birefringence medium 218 is guided in the second optical path, leading to the BS 133, and consequently the first optical signal is delayed by less than one bit.

Subsequently, the BS 133 causes the first optical signal guided in the first optical path or the second optical path by the birefringence medium 218 and the second optical signal input from the phase adjustment device 128 to interfere with each other (step S38). The normal phase component of the interference signal output from the BS 133 is input into the PBS 124 via the mirror 134 and the reverse phase component of the interference is input into the PBS 125.

Subsequently, the PBS 124 combines the normal phase component of the interference signal input from the BS 121 and the normal phase component of the interference signal input from the mirror 134 in a state where the polarization directions are perpendicular to each other. Along with this, the PBS 125 combines the reverse phase component of the interference signal input from the mirror 122 and the reverse phase component of the interference signal input from the BS 133 in a state where the polarization directions are perpendicular to each other (step S39). Then, the PBS 124 and the PBS 125 output the combined optical signals as the normal phase component and the reverse phase component of the demodulated signal to the receiver 102, respectively (step S40). The normal phase component and the reverse phase component of the demodulated signal output from the PBS 124 and the PBS 125 are input into the bit judging device 103 via the receiver 102. The bit judging device 103 measures the BER of the input demodulated signal and outputs it to the liquid crystal controller 221 of the delayed interferometer 201.

Subsequently, the liquid crystal controller 221 judges the BER input from the bit judging device 103 to control the liquid crystal 212, 214, 217, 219, and adjusts the polarization direction of the first optical signal input into the birefringence medium 213, 218 in the horizontal direction or the vertical direction (step S41).

As described above, the delayed interferometer 201 according to the third embodiment uses the birefringence medium 213, 218 for refracting the optical signal in a path having a different optical distance depending on the polarization direction of the input optical signal to guide the first optical signal to the first optical path or the second optical path. Thus, the delayed interferometer 201 can use the existing optical component such as birefringence medium to easily guide the first optical signal in the first optical path or the second optical path. Since the delayed interferometer 201 contains the path itself on which the optical signal is to be refracted inside the birefringence medium 213, 218, the device structure can be simplified and thus a small-sized device can be realized.

### [d] Fourth Embodiment

The third embodiment describes the example in which the delayed interferometer disclosed in the present application is applied to a Mach-Zehnder delayed interferometer. However, the delayed interferometer disclosed in the present application may be applied to a so-called Michelson delayed interferometer. The fourth embodiment describes an example in which the delayed interferometer disclosed in the present application is applied to the Michelson delayed interferometer.

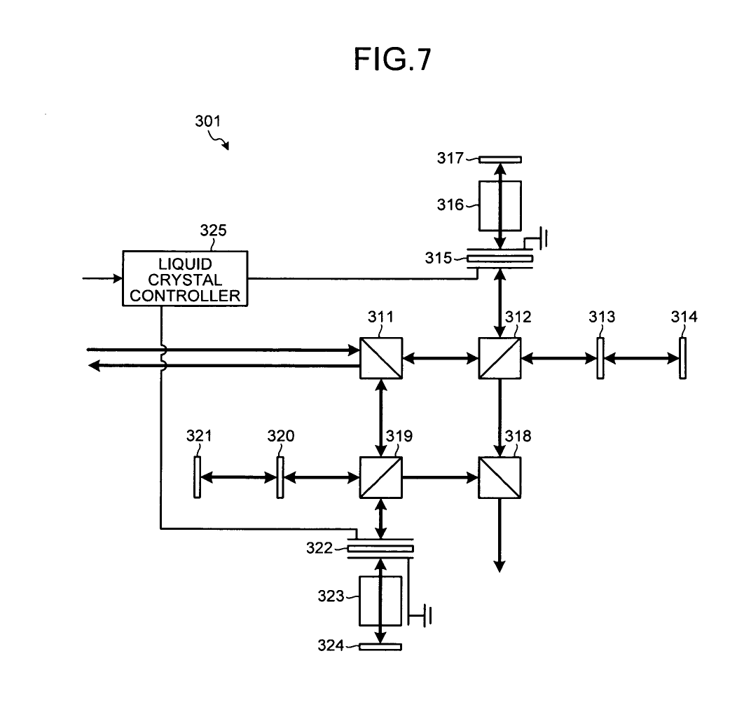

FIG. 7 is a diagram illustrating a structure of a delayed interferometer 301 according to the fourth embodiment. The delayed interferometer 301 illustrated in FIG. 7 is one example of the Michelson delayed interferometer. A structure of the optical receiver including the delayed interferometer 301 according to the fourth embodiment is similar to the structure illustrated in FIG. 2 and the explanation thereof will be omitted herein.

As illustrated, the delayed interferometer 301 according to the fourth embodiment includes a PBS 311, a BS 312, a phase adjustment device 313, a mirror 314, liquid crystal 315, a birefringence medium 316, a mirror 317 and a PBS 318. The delayed interferometer 301 further includes a BS 319, a phase adjustment device 320, a mirror 321, liquid crystal 322, a birefringence medium 323, a mirror 324 and a liquid crystal controller 325.

The PBS 311 branches a modulated signal input from the optical transmitter into a first modulated signal and a second modulated signal which are perpendicular to each other in the polarization direction to output the first modulated signal to the BS 312 and to output the second modulated signal to the BS 319. For example, the PBS 311 transmits the horizontal modulated signal whose polarization direction is horizontal among the modulated signals as the first modulated signal to the BS 312, and reflects the vertical modulated signal whose polarization direction is vertical as the second modulated signal to the BS 319.

The PBS 311 combines the normal phase component of the interference signal input from the BS 312 and the normal phase component of the interference signal input from the BS 319 in a state where the polarization directions are perpendicular to each other, and outputs the combined optical signal as the normal phase component of the demodulated signal to the receiver 102.

The BS 312 branches the first modulated signal input from the PBS 311 into a first optical signal and a second optical signal to output the first optical signal to the liquid crystal 315 and to output the second optical signal to the phase adjustment device 313. For example, the BS 312 reflects half of the first modulated signal input from the PBS 311 as the first optical signal to the liquid crystal 315 and transmits the remaining half of the first modulated signal as the second optical signal to the phase adjustment device 313. The BS 312 is one example of the branching unit 1 according to the first embodiment.

The BS 312 causes the first optical signal input from the mirror 317 via the birefringence medium 316 and the liquid crystal 315 and the second optical signal input from the mirror 314 via the phase adjustment device 313 to interfere with each other. The BS 312 outputs the normal phase component of the interference signal as the interfered optical signal to the PBS 311 and outputs the reverse phase component of the interference signal to the PBS 318.

The phase adjustment device 313 finely adjusts a length of the optical path of the second optical signal input from the BS 312 and outputs the finely-adjusted second optical signal to the mirror 314 in order to change wavelengths strengthened in the delayed interferometer 301. For example, the phase adjustment device 313 controls a temperature of a medium such as glass, which varies in refraction index depending on the temperature, to finely adjust the length of the optical path of the second optical signal, and outputs the finely-adjusted second optical signal to the mirror 314. The mirror 314 reflects the second optical signal input from the phase adjustment device 313 and outputs it to the BS 312 via the phase adjustment device 313.

The liquid crystal 315 rotates the polarization direction of the first optical signal input from the BS 312 by 0° or 90°, and outputs the rotated first optical signal to the birefringence medium 316. The liquid crystal 315 rotates the polarization direction of the first optical signal input from the mirror 317 via the birefringence medium 316 by 0° or 90° to return to the horizontal direction, and outputs the rotated first optical signal to the BS 312. The liquid crystal 315 judges whether to rotate the polarization direction of the first optical signal by 0° or 90° depending on the voltage applied from the liquid crystal controller 325 described later.

The birefringence medium 316 refracts an optical signal in a path having a different optical distance depending on the polarization direction of the input optical signal and is of calcite, rutile or YVO₄, for example. The birefringence medium 316 is arranged to be sandwiched between the liquid crystal 315 and the mirror 317. The birefringence medium 316 refracts the first optical signal in a path having a different optical distance depending on the polarization direction of the first optical signal input from the liquid crystal 315, and outputs the refracted first optical signal to the mirror 317. Specifically, when the polarization direction of the first optical signal is horizontal, the birefringence medium 316 refracts the first optical signal in a path having a maximum optical distance (which will be called “maximum path” below). On the other hand, when the polarization direction of the first optical signal is vertical, the birefringence medium 316 refracts the first optical signal in a path having a minimum optical distance (which will be called “minimum path” below). Then, the birefringence medium 316 outputs the first optical signal refracted in the maximum path or the minimum path to the mirror 317.

The birefringence medium 316 refracts the first optical signal input from the mirror 317 in the maximum path or the minimum path depending on the polarization direction of the first optical signal, and outputs the refracted first optical signal to the liquid crystal 315. The meaning of refracting the first optical signal in the maximum path or the minimum path by the birefringence medium 316 will be described later.

The mirror 317 reflects the first optical signal input from the birefringence medium 316 and outputs it to the liquid crystal 315 via the birefringence medium 316.

The meaning of refracting the first optical signal in the maximum path or the minimum path by the birefringence medium 316 will be described herein. An optical path from the BS 312 through the liquid crystal 315, the maximum path of the birefringence medium 316, the mirror 317, the maximum path of the birefringence medium 316 and the liquid crystal 315 to the BS 312 (which will be called “first optical path” below) is preset at an optical distance for delaying the first optical signal by one bit. On the other hand, an optical path from the BS 312 through the liquid crystal 315, the minimum path of the birefringence medium 316, the mirror 317, the minimum path of the birefringence medium 316 and the liquid crystal 315 to the BS 312 (which will be called “second optical path” below) is preset at an optical distance shorter than that of the first optical path. Then, as stated above, the birefringence medium 316 refracts the first optical signal in the maximum path or the minimum path depending on the polarization direction of the first optical signal, and outputs the first optical signal refracted in the maximum path or the minimum path to the mirror 317 or the liquid crystal 315. The first optical signal refracted in the maximum path by the birefringence medium 316 is guided in the first optical path and thus is delayed by one bit. The first optical signal refracted in the minimum path by the birefringence medium 316 is guided in the second optical path and thus is delayed by less than one bit. In other words, the birefringence medium 316 refracts the first optical signal in the maximum path or the minimum path depending on the polarization direction of the first optical signal, and guides the first optical signal to the first optical path or the second optical path having a mutually different optical distance. Thus, the birefringence medium 316 corresponds to one example of the guiding unit 2 according to the first embodiment.

The PBS 318 combines the reverse phase component of the interference signal input from the BS 312 and the reverse phase component of the interference signal input from the BS 319 in a state where the polarization directions are perpendicular to each other, and outputs the combined optical signal as the reverse phase component of the demodulated signal to the receiver 102.

The BS 319 branches the second modulated signal input from the PBS 311 into a first optical signal and a second optical signal to output the first optical signal to the liquid crystal 322 and to output the second optical signal to the phase adjustment device 320. For example, the BS 319 transmits half of the second modulated signal input from the PBS 311 as the first optical signal to the liquid crystal 322 and reflects the remaining half of the second modulated signal as the second optical signal to the phase adjustment device 320. The BS 319 is one example of the branching unit 1 according to the first embodiment.

The BS 319 causes the first optical signal input from the mirror 324 via the birefringence medium 323 and the liquid crystal 322 and the second optical signal input from the mirror 321 via the phase adjustment device 320 to interfere with each other. Then, the BS 319 outputs the normal phase component of the interference signal as the interfered optical signal to the PBS 311 and outputs the reverse phase component of the interference signal to the PBS 318. The PBS 311, the BS 312, the PBS 318 and the BS 319 are examples of the demodulating unit 3 according to the first embodiment.

The phase adjustment device 320 finely adjusts a length of the optical path of the second optical signal input from the BS 319 and outputs the finely-adjusted second optical signal to the mirror 321 in order to change wavelengths strengthened in the delayed interferometer 301. The mirror 321 reflects the second optical signal input from the phase adjustment device 320 and outputs it to the BS 319 via the phase adjustment device 320.

The liquid crystal 322 rotates the polarization direction of the first optical signal input from the BS 319 by 0° or 90°, and outputs the rotated first optical signal to the birefringence medium 323. The liquid crystal 322 rotates the polarization direction of the first optical signal input from the mirror 324 via the birefringence medium 323 by 0° or 90° to return to the vertical direction, and outputs the rotated first optical signal to the BS 319. The liquid crystal 322 judges whether to rotate the polarization direction of the first optical signal by 0° or 90° depending on the voltage applied from the liquid crystal controller 325 described later.

The birefringence medium 323 refracts an optical signal in a path having a different optical distance depending on the polarization direction of the input optical signal, and is of calcite, rutile or YVO₄, for example. The birefringence medium 323 is arranged to be sandwiched between the liquid crystal 322 and the mirror 324. The birefringence medium 323 refracts the first optical signal in a path having a different optical distance depending on the polarization direction of the first optical signal input from the liquid crystal 322, and outputs the refracted first optical signal to the mirror 324. Specifically, when the polarization direction of the first optical signal is vertical, the birefringence medium 323 refracts the first optical signal in the maximum path. On the other hand, when the polarization direction of the first optical signal is horizontal, the birefringence medium 323 refracts the first optical signal in the minimum path. The birefringence medium 323 outputs the first optical signal refracted in the maximum path or the minimum path to the mirror 324.

The birefringence medium 323 reflects the first optical signal input from the mirror 324 and outputs it to the liquid crystal 322 via the birefringence medium 323.

The meaning of refracting the first optical signal in the maximum path or the minimum path by the birefringence medium 323 will be described herein. An optical path from the BS 319 through the liquid crystal 322, the maximum path of the birefringence medium 323, the mirror 324, the maximum path of the birefringence medium 323 and the liquid crystal 322 to the BS 319 (which will be called “first optical path” below) is preset at an optical distance for delaying the first optical signal by one bit. On the other hand, an optical path from the BS 319 through the liquid crystal 322, the minimum path of the birefringence medium 323, the mirror 324, the minimum path of the birefringence medium 323 and the liquid crystal 322 to the BS 319 (which will be called “second optical path” below) is preset at an optical distance shorter than that of the first optical path. Then, as stated above, the birefringence medium 323 refracts the first optical signal in the maximum path or the minimum path depending on the polarization direction of the first optical signal, and outputs the first optical signal refracted in the maximum path or the minimum path to the mirror 324 or the liquid crystal 322. The first optical signal refracted in the maximum path by the birefringence medium 323 is guided in the first optical path and thus is delayed by one bit. The first optical signal refracted in the minimum path by the birefringence medium 323 is guided in the second optical path and thus is delayed by less than one bit. In other words, the birefringence medium 323 refracts the first optical signal in the maximum path or the minimum path depending on the polarization direction of the first optical signal, and guides the first optical signal to the first optical path or the second optical path having a mutually different optical distance. Thereby, the birefringence medium 323 corresponds to one example of the guiding unit 2 according to the first embodiment.

The liquid crystal controller 325 judges the BER of the demodulated signal input from the bit judging device 103 to control the liquid crystal 315, 322, and adjusts the polarization direction of the first optical signal input into the birefringence medium 316, 323 in the horizontal direction or the vertical direction. The liquid crystal controller 325 is one example of the polarization direction adjusting unit 4 according to the first embodiment.

A processing of adjusting the polarization direction by the liquid crystal controller 325 will be specifically described herein. In the following, it is assumed that the PBS 111 outputs the horizontal modulated signal as the first modulated signal to the BS 312 and outputs the vertical modulated signal as the second modulated signal to the BS 319. It is assumed that the liquid crystal 315 rotates the polarization direction of the first optical signal input from the BS 312 by 0° and outputs the rotated first optical signal to the birefringence medium 316. It is assumed that the liquid crystal 322 rotates the polarization direction of the first optical signal input from the BS 319 by 0° and outputs the rotated first optical signal to the birefringence medium 323.

Under the situation, the BS 312 branches the horizontal modulated signal input from the PBS 311 into a first optical signal and a second optical signal and outputs the first optical signal to the liquid crystal 315. The liquid crystal 315 maintains the polarization direction of the first optical signal input from the BS 312 in the horizontal direction as is, and outputs the first optical signal to the birefringence medium 316. Since the polarization direction of the first optical signal input from the liquid crystal 315 is horizontal, the birefringence medium 316 refracts the first optical signal in the maximum path and outputs the refracted first optical signal to the mirror 317. The mirror 317 reflects the first optical signal input from the birefringence medium 316 and outputs it to the birefringence medium 316. Since the polarization direction of the first optical signal input from the mirror 317 is horizontal, the birefringence medium 316 refracts the first optical signal in the maximum path and outputs the refracted first optical signal to the liquid crystal 315. The liquid crystal 315 maintains the polarization direction of the first optical signal input from the birefringence medium 316 in the horizontal direction as is, and outputs the first optical signal to the BS 312. In other words, the first optical signal refracted in the maximum path by the birefringence medium 316 is guided in the first optical path and thus is delayed by one bit.

On the other hand, the BS 319 branches the vertical modulated signal input from the PBS 311 into a first optical signal and a second optical signal and outputs the first optical signal to the liquid crystal 322. The liquid crystal 322 maintains the polarization direction of the first optical signal input from the BS 319 in the vertical direction as is, and outputs the first optical signal to the birefringence medium 323. Since the polarization direction of the first optical signal input from the liquid crystal 322 is vertical, the birefringence medium 323 refracts the first optical signal in the maximum path and outputs the refracted first optical signal to the mirror 324. The mirror 324 reflects the first optical signal input from the birefringence medium 323 and outputs it to the birefringence medium 323. Since the polarization direction of the first optical signal input from the mirror 324 is vertical, the birefringence medium 323 refracts the first optical signal in the maximum path and outputs the refracted first optical signal to the liquid crystal 322. The liquid crystal 322 maintains the polarization direction of the first optical signal input from the birefringence medium 323 in the horizontal direction as is, and outputs the first optical signal to the BS 319. In other words, the first optical signal refracted in the maximum path by the birefringence medium 323 is guided in the first optical path and thus is delayed by one bit.

Then, the liquid crystal controller 325 judges whether the variation of the BER of the demodulated signal input from the bit judging device 103 is the predetermined threshold or more. A factor of the variation of the BER of the demodulated signal may assume that an external device such as interleaver is additionally arranged on a transmission path upstream of the delayed interferometer 301, for example. When it is determined that the variation of the BER of the demodulated signal is smaller than the predetermined threshold, the liquid crystal controller 325 does not perform the processing of adjusting the polarization direction.

On the other hand, when it is determined that the variation of the BER of the demodulated signal is the predetermined threshold or more, the liquid crystal controller 325 stops applying a voltage to the liquid crystal 315, 322. When the voltage stops being applied from the liquid crystal controller 325, the liquid crystal 315 rotates the polarization direction of the first optical signal input from the BS 312 by 90° to be vertical, and outputs the rotated first optical signal to the birefringence medium 316. Since the polarization direction of the first optical signal input from the liquid crystal 315 is vertical, the birefringence medium 316 refracts the first optical signal in the minimum path and outputs the refracted first optical signal to the mirror 317. The mirror 317 reflects the first optical signal input from the birefringence medium 316 and outputs it to the birefringence medium 316. Since the polarization direction of the first optical signal input from the mirror 317 is vertical, the birefringence medium 316 refracts the first optical signal in the minimum path and outputs the refracted first optical signal to the liquid crystal 315. The liquid crystal 315 rotates the polarization direction of the first optical signal input from the birefringence medium 316 by 90° to return to the horizontal direction, and outputs the rotated first optical signal to the BS 312. In other words, the first optical signal refracted in the minimum path by the birefringence medium 316 is guided in the second optical path and thus is delayed by less than one bit.

On the other hand, when the voltage stops being applied from the liquid crystal controller 325, the liquid crystal 322 rotates the polarization direction of the first optical signal input from the BS 319 by 90° to be horizontal, and outputs the rotated first optical signal to the birefringence medium 323. Since the polarization direction of the first optical signal input from the liquid crystal 322 is horizontal, the birefringence medium 323 refracts the first optical signal in the minimum path and outputs the refracted first optical signal to the mirror 324. The mirror 324 reflects the first optical signal input from the birefringence medium 323 and outputs it to the birefringence medium 323. Since the polarization direction of the first optical signal input from the mirror 324 is horizontal, the birefringence medium 323 refracts the first optical signal in the minimum path and outputs the refracted first optical signal to the liquid crystal 322. The liquid crystal 322 rotates the polarization direction of the first optical signal input from the birefringence medium 323 by 90° to return to the vertical direction, and outputs the rotated first optical signal to the BS 319. In other words, the first optical signal refracted in the minimum path by the birefringence medium 323 is guided in the second optical path and thus is delayed by less than one bit.

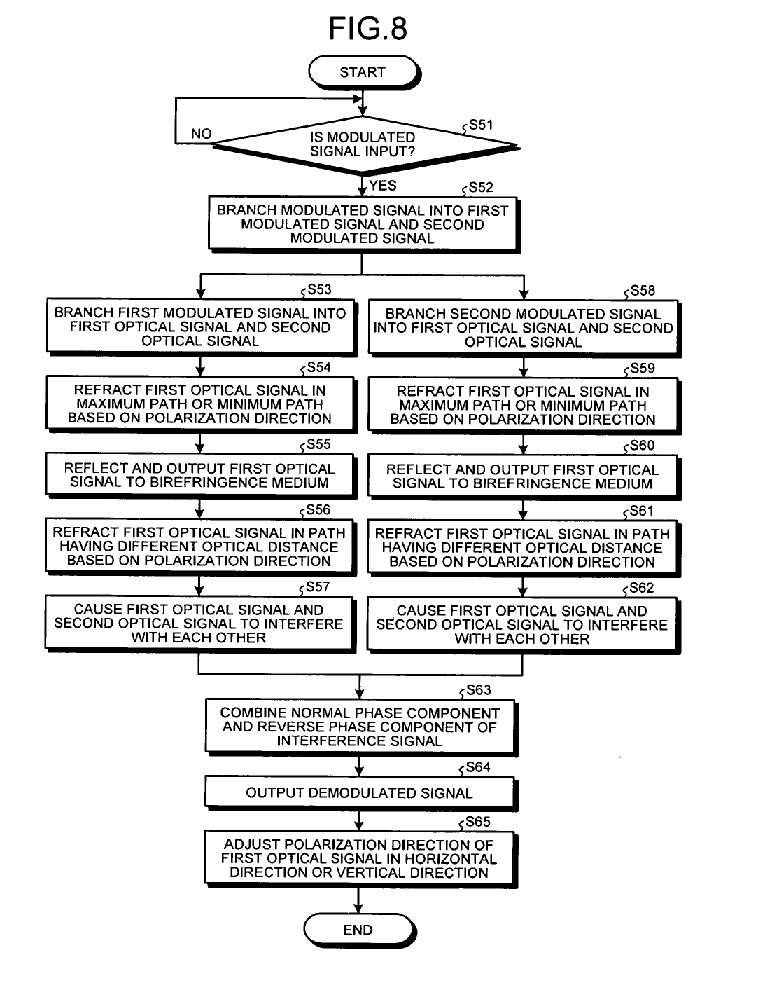

A processing procedure by the delayed interferometer 301 according to the fourth embodiment will be described below. FIG. 8 is a flowchart illustrating the processing procedure by the delayed interferometer 301 according to the fourth embodiment. As illustrated, the delayed interferometer 301 waits until a modulated signal is input from the optical transmitter (step S51: No). When the modulated signal is input from the optical transmitter (step S51: Yes), the PBS 311 of the delayed interferometer 301 branches the modulated signal into a first modulated signal and a second modulated signal which are perpendicular to each other in the polarization direction (step S52). The first modulated signal branched by the PBS 311 is input into the BS 312 and the second modulated signal is input into the BS 319.

Then, the BS 312 branches the first modulated signal input from the PBS 311 into a first optical signal and a second optical signal (step S53). The first optical signal branched by the BS 312 is input into the birefringence medium 316 via the liquid crystal 315 and the second optical signal is input into the BS 312 via the phase adjustment device 313 and the mirror 314.

Subsequently, the birefringence medium 316 refracts the first optical signal in a path having a different optical distance depending on the polarization direction of the first optical signal input from the liquid crystal 315 (step S54). Specifically, when the polarization direction of the first optical signal is horizontal, the birefringence medium 316 refracts the first optical signal in the maximum path. On the other hand, when the polarization direction of the first optical signal is vertical, the birefringence medium 316 refracts the first optical signal in the minimum path. Then, the birefringence medium 316 outputs the first optical signal refracted in the maximum path or the minimum path to the mirror 317.

Subsequently, the mirror 317 reflects the first optical signal input from the birefringence medium 316 and outputs it to the birefringence medium 316 (step S55). Subsequently, the birefringence medium 316 refracts the first optical signal in the maximum path or the minimum path depending on the polarization direction of the first optical signal input from the mirror 317 (step S56). The first optical signal refracted in the maximum path by the birefringence medium 316 is guided in the first optical path, leading to the BS 312, and consequently the first optical signal is delayed by one bit. The first optical signal refracted in the minimum path by the birefringence medium 316 is guided in the second optical path, leading to the BS 312, and consequently the first optical signal is delayed by less than one bit.

Subsequently, the BS 312 causes the first optical signal guided in the first optical path or the second optical path by the birefringence medium 316 and the second optical signal input from the phase adjustment device 313 to interfere with each other (step S57). The normal phase component of the interference signal output from the BS 312 is input into the PBS 311 and the reverse phase component of the interference is input into the PBS 318.

The BS 319 branches the second modulated signal input from the PBS 311 into a first optical signal and a second optical signal (step S58). The first optical signal branched by the BS 319 is input into the birefringence medium 323 via the liquid crystal 322 and the second optical signal is input into the BS 319 via the phase adjustment device 320 and the mirror 321.

Subsequently, the birefringence medium 323 refracts the first optical signal in a path having a different optical distance depending on the polarization direction of the first optical signal input from the liquid crystal 322 (step S59). Specifically, when the polarization direction of the first optical signal is vertical, the birefringence medium 323 refracts the first optical signal in the maximum path. On the other hand, when the polarization direction of the first optical signal is horizontal, the birefringence medium 323 refracts the first optical signal in the minimum path. Then, the birefringence medium 323 outputs the first optical signal refracted in the maximum path or the minimum path to the mirror 324.

Subsequently, the mirror 324 reflects the first optical signal input from the birefringence medium 323 and outputs it to the birefringence medium 323 (step S60). Subsequently, the birefringence medium 323 refracts the first optical signal in the maximum path or the minimum path depending on the polarization direction of the first optical signal input from the mirror 324 (step S61). The first optical signal refracted in the maximum path by the birefringence medium 323 is guided in the first optical path, leading to the BS 319, and consequently the first optical signal is delayed by one bit. The first optical signal refracted in the minimum path by the birefringence medium 323 is guided in the second optical path, leading to the BS 319, and consequently the first optical signal is delayed by less than one bit.

Subsequently, the BS 319 causes the first optical signal guided in the first optical path or the second optical path by the birefringence medium 323 and the second optical signal input from the phase adjustment device 320 to interfere with each other (step S62). The normal phase component of the interference signal output from the BS 319 is input into the PBS 311 and the reverse phase component of the interference signal is input into the PBS 318.

Subsequently, the PBS 311 combines the normal phase component of the interference signal input from the BS 312 and the normal phase component of the interference signal input from the BS 319 in a state where the polarization directions are perpendicular to each other. Along with this, the PBS 318 combines the reverse phase component of the interference signal input from the BS 312 and the reverse phase component of the interference signal input from the BS 319 in a state where the polarization directions are perpendicular to each other (step S63). Then, the PBS 311 and the PBS 318 output the combined optical signals as the normal phase component and the reverse phase component of the demodulated signal to the receiver 102, respectively (step S64). The normal phase component and the reverse phase component of the demodulated signal output from the PBS 311 and the PBS 318 are input into the bit judging device 103 via the receiver 102. The bit judging device 103 measures the BER of the input demodulated signal and outputs it to the liquid crystal controller 325 of the delayed interferometer 301.

Subsequently, the liquid crystal controller 325 judges the BER input from the bit judging device 103 to control the liquid crystal 315, 322, and adjusts the polarization direction of the first optical signal input into the birefringence medium 316, 323 in the horizontal direction or the vertical direction (step S65).

As described above, the delayed interferometer 301 according to the fourth embodiment uses the birefringence medium 316, 323 for refracting an optical signal in a path having a different optical distance depending on the polarization direction of the input optical signal to guide the first optical signal in the first optical path or the second optical path. Thus, the delayed interferometer 301 can use the existing optical component such as birefringence medium to easily guide the first optical signal in the first optical path or the second optical path.

The delayed interferometer 301 is configured as a Michelson delayed interferometer. Specifically, the delayed interferometer 301 branches the modulated signal into the first optical signal and the second optical signal by the BS 312, 319, and causes the branched first optical signal and second optical signal to interfere with each other by the BS 312, 319. In other words, the delayed interferometer 301 uses the branching function of the optical signal and the interfering function of the optical signal in the common BS 312, 319. Thereby, the delayed interferometer 301 can reduce the number of optical components, thereby preventing the device from becoming larger in size.

### [e] Fifth Embodiment

The delayed interferometer disclosed in the present application may be executed in various different forms other than the above embodiments. The fifth embodiment describes other examples of the delayed interferometer disclosed in the present application, and the like.

Polarization Direction Adjusting Method

The third and fourth embodiments describe the example in which the delayed interferometer disclosed in the present application uses the liquid crystal to adjust the polarization direction of the optical signal input into the birefringence medium either in the horizontal direction or in the vertical direction. However, the delayed interferometer disclosed in the present application is not limited thereto. For example, the delayed interferometer disclosed in the present application may use a polarization controller capable of freely adjusting an optical axis to adjust the polarization direction of the optical signal input into the birefringence medium in a desired direction. In this manner, the polarization direction of the optical signal input into the birefringence medium by the polarization controller is adjusted in a desired direction, thereby finely changing the amount of delay of the modulated signal.

According to the disclosed delayed interferometer, there is obtained an effect that the amount of delay of an optical signal can be accurately changed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A delayed interferometer comprising:
a branching unit that branches an optical signal modulated by a phase modulation system into a first optical signal and a second optical signal;
a guiding unit that acquires the first optical signal branched by the branching unit, guides the first optical signal in a first optical path to delay the first optical signal by one bit when a polarization direction of the acquired first optical signal is the first direction, and guides the first optical signal in a second optical path having an optical distance shorter than that of the first optical path when the polarization direction of the first optical signal is the second direction perpendicular to the first direction;
a demodulating unit that causes the first optical signal guided in the first optical path or the second optical path by the guiding unit and the second optical signal branched by the branching unit to interfere with each other, thereby demodulating the optical signal; and
a polarization direction adjusting unit that judges a code error rate of the optical signal demodulated by the demodulating unit to adjust the polarization direction of the first optical signal acquired by the guiding unit in the first direction or the second direction.

2. The delayed interferometer according to claim 1,
wherein the polarization direction adjusting unit uses liquid crystal to rotate a polarization direction of an input optical signal by 0° or 90° to adjust the polarization direction of the first optical signal in the first direction or the second direction.

3. The delayed interferometer according to claim 1,
wherein the guiding unit uses a polarization beam splitter to reflect or transmit an input optical signal depending on the polarization direction of the input optical signal to guide the first optical signal in the first optical path or the second optical path.

4. The delayed interferometer according to claim 1,
wherein the guiding unit uses a birefringence medium to refract an input optical signal in one of a plurality of paths each of the plurality of path has a different optical distance respectively depending on the polarization direction of the input optical signal to guide the first optical signal in the first optical path or the second optical path.

5. An optical receiver comprising:
a branching unit that branches an optical signal modulated by a phase modulation system into a first optical signal and a second optical signal;
a guiding unit that acquires the first optical signal branched by the branching unit, guides the first optical signal in a first optical path to delay the first optical signal by one bit when a polarization direction of the acquired first optical signal is the first direction, and guides the first optical signal in a second optical path having an optical distance shorter than that of the first optical path when the polarization direction of the first optical signal is the second direction perpendicular to the first direction;
a demodulating unit that causes the first optical signal guided in the first optical path or the second optical path by the guiding unit and the second optical signal branched by the branching unit to interfere with each other, thereby demodulating the optical signal; and
a polarization direction adjusting unit that judges a code error rate of the optical signal demodulated by the demodulating unit to adjust the polarization direction of the first optical signal acquired by the guiding unit in the first direction or the second direction.

6. A delayed interferometer comprising:
a first splitter that branches an optical signal modulated by a phase modulation system into a first optical signal and a second optical signal;
a second splitter that acquires the first optical signal branched by the first splitter, guides the first optical signal in a first optical path to delay the first optical signal when a polarization direction of the acquired first optical signal is the first direction, and guides the first optical signal in a second optical path having an optical distance shorter than that of the first optical path when the polarization direction of the first optical signal is the second direction perpendicular to the first direction;
a third splitter that causes the first optical signal guided in the first optical path or the second optical path by the second splitter and the second optical signal branched by the first splitter to interfere with each other, thereby demodulating the optical signal; and
a liquid crystal controller that judges a code error rate of the optical signal demodulated by the third splitter to adjust the polarization direction of the first optical signal acquired by the second splitter in the first direction or the second direction.
